(19) United States
(12) Patent Application Publication
(10) Pub. No.: US 2008/0167953 A1
(43) Pub. Date: Jul. 10, 2008

(54) Method and apparatus for location-aware job tracking correlated with multimedia information

(75) Inventors: Sanjay S. Shirole, Palo Alto, CA (US); Ananth Rani, Fremont, CA (US); Pramod Jajoo, Bangalore (IN); Justin C. Falk, Mountain View, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: Xora, Inc., Mountain View, CA (US)

(21) Appl. No.: 11/649,413

(22) Filed: Jan. 4, 2007

(51) Int. Cl. G06Q 10/00

(52) U.S. Cl. 705/11

(57) ABSTRACT

Method and apparatus for job tracking is described. One aspect of the invention relates to tracking performance of a job. An interface is configured to capture multimedia data related to the job. A time capturing module is configured to track time-of-day. A location module is configured to determine location. A multimedia client is configured to produce a job table for the job that includes the multimedia data, time-of-day information from the time capturing module, and location information from the location module. A cellular transceiver is configured to transmit the job table to a server via a wireless mobile network. In this manner, an employer may obtain information with respect to performance of a job in real-time and automatically from the employee.

### BACKGROUND OF THE INVENTION

1. Field of the Invention

Embodiments of the invention generally relate to tracking jobs done by employees at various job locations and, more particularly related to using multimedia content to track the jobs done by the employees.

2. Description of the Related Art

In today's world of automation and computerization, there are still some business applications not fully reached by information technology. One such example is in the package delivery industry, e.g., consignment, couriers, etc. Conventionally, if a consignment is sent to a customer through a courier, the customer has to fill out a hard copy form, which provides a “proof of job,” memorializing the consignment and its delivery. Typically, proof of job provides evidence that the job has been successfully delivered at the correct location. In a typical example, the employee of the delivery company provides the hard copy of the proof of job to the employer, after completing his job cycle for the day. One of the biggest obstacles to such a paper-based environment is that employer has no way to track whether the job delivery is done at the correct location. Even if it is tracked, there is always a time-lag between a delivery to a wrong location and the realization of the mistaken delivery. Additionally, it is possible for employees defraud their employers and/or their customers by reporting as completed jobs that were not delivered correctly. Further, some customers may get back to the consigner at a later date with a fraud complaint, stating that the goods were not properly delivered or were delivered in an unacceptable condition. Hence, hard copies are not a reliable way to provide an accurate and timely proof of job.

One known way to get a reliable proof of job is by providing a peripheral device with a camera to the employees, which they may then carry to the location of the job delivery. The employee may then capture the proof of job with the camera, storing it in the peripheral. However, the captured proof of job does not get transmitted or uploaded to the employer in real time. Rather, the employee generally updates the captured proof of job to the employer after completion of the job cycle for the day or perhaps at several times during the day. Thus, once again, there is a time-lag between the job delivery and updating the employer about the same.

Therefore, there is need for a method and apparatus for job tracking that provides an employer real time access to the present status of a job.

### SUMMARY OF THE INVENTION

Method and apparatus for job tracking is described. One aspect of the invention relates to tracking performance of a job. An interface is configured to capture multimedia data related to the job. A time capturing module is configured to track time-of-day. A location module is configured to determine location. A multimedia client is configured to produce a job table for the job that includes the multimedia data, time-of-day information from the time capturing module, and location information from the location module. A cellular transceiver is configured to transmit the job table to a server via a wireless mobile network. In this manner, an employer may obtain information with respect to performance of a job in real-time and automatically from the employee.,

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a job tracking system in accordance with one or more aspects of the invention;

FIG. 2 is a block diagram representation of a job tracking system for tracking the jobs done by the employees at the various job locations, according to an exemplary embodiment of the present invention;

FIG. 3 is a flowchart of a method for tracking performance of a job, according to an exemplary embodiment of the present invention;

FIG. 4 is a flowchart of a method of uploading a job table to a database, according to an exemplary embodiment of the invention; and

FIG. 5 is an exemplary illustration of a job table in accordance with one embodiment of the invention.

### DETAILED DESCRIPTION

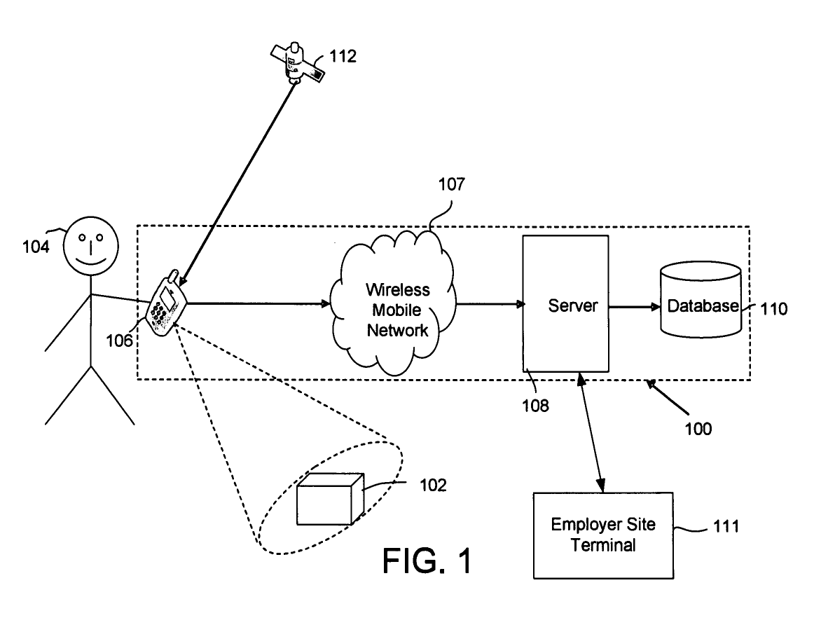

FIG. 1 is a block diagram of a job tracking system 100 in accordance with one or more aspects of the invention. In an embodiment, the system 100 is designed to communicate and receive multimedia information related to jobs from persons assigned to such jobs through a wireless network. A “job” may include various types of activities for which a person or persons assigned to the job must travel to a job site to perform. Exemplary jobs include, without limitation, delivery of an object, repair of household problems (e.g., electricians, plumbers, etc.), and other jobs in which a person assigned to the job must travel to a job site or delivery location. In an illustrative embodiment, the job tracking system 100 is configured to provide multimedia content as a proof of delivery of an object 102 by an employee 104. Those skilled in the art will appreciate that a job tracking system of the invention may provide multimedia content to be used for other job-related purposes, such as proof of an employee's visit to a job site, verification of prevailing conditions at a job site (e.g., video or image data), description of prevailing conditions at a job site (e.g., voice notes), and the like.

The job tracking system 100 comprises a mobile device 106, a server 108 and a database 110 connected to server 108. In the embodiment shown, the mobile device 106 comprises a cellular telephone (“cell phone”). It is to be understood that other types of mobile devices may be employed, such as personal digital assistants (PDAs) and the like. The mobile device 106 is configured to capture multimedia content related to one or more jobs. For example, the mobile device 106 may capture multimedia content related to delivery of the object 102 (e.g., a picture of the object, a video including the object, voice notes from the employee 104, etc.). The mobile device 106 is configured to form a job table for each job that relates the multimedia content, time-of-day information, and location information. The mobile device 106 is also configured for communication with a wireless mobile network 107. In one embodiment of the invention, the wireless mobile network 107 is a conventional cellular network. Those skilled in the art will appreciate that various wireless mobile networks may be employed in various embodiments of the present invention including, without limitation, a Global System for Mobile communication (GSM) network, a Code Division Multiple Access (CDMA) network, and the like. In an embodiment, the mobile device 106 is configured to compute its position in a well known manner using a satellite positioning system (SPS) 112, such as the global positioning system (GPS) or the like. Alternatively, the mobile device 106 may compute its position via the wireless mobile network 107 using one or more well known techniques.

In an exemplary system, the mobile device 106 is coupled to the server 108 through the wireless mobile network 107. The mobile device 106 transmits the job table data for the jobs to the server 108 using the wireless mobile network 107. The server 108 is a data processing device. Those skilled in the art will appreciate that various forms of data processing devices may be employed in various embodiments of the present invention including, without limitation, personal computers, servers, mainframes, and the like. The server 108 stores the job table data in the database 110. The database 110 is a logical unit of storage. In an embodiment, the database 110 may be formed from a portion of the overall storage of a physical device, by the storage of an entire physical device or by the storage of multiple physical devices combined together. The database 110 may also form part of the memory in the server 110.

In one embodiment of the present invention, the job table data stored in database 110 is transferred to update an employer site terminal 111. The employer site terminal 111 and server 108 may be at the same location or at geographically distinct locations. Examples of transfers of such data include, but are not limited to, transfers (uploads, downloads, e-mail, etc.) over the Internet and/or other computer networks via one or more data transfer protocols (e.g., HTTP, FTP, SMTP, etc.). In this manner, an employer may track the progress of one or more jobs assigned to the employee 104 in real-time.

In an embodiment, the employee 104 needs to capture the proof that the job has been completed. The mobile device 106 is configured to capture multimedia content related to the job, as well as time-of-day and location information to provide proof of job. For example, a courier delivery person may capture an image of the object delivered to the recipient. In one embodiment of the invention, the employee 104 may capture the multimedia content at the beginning and at completion of the job. For example, an electrician or a plumber may capture the images of the object on which the work is to be done before starting the work and after completing the work.

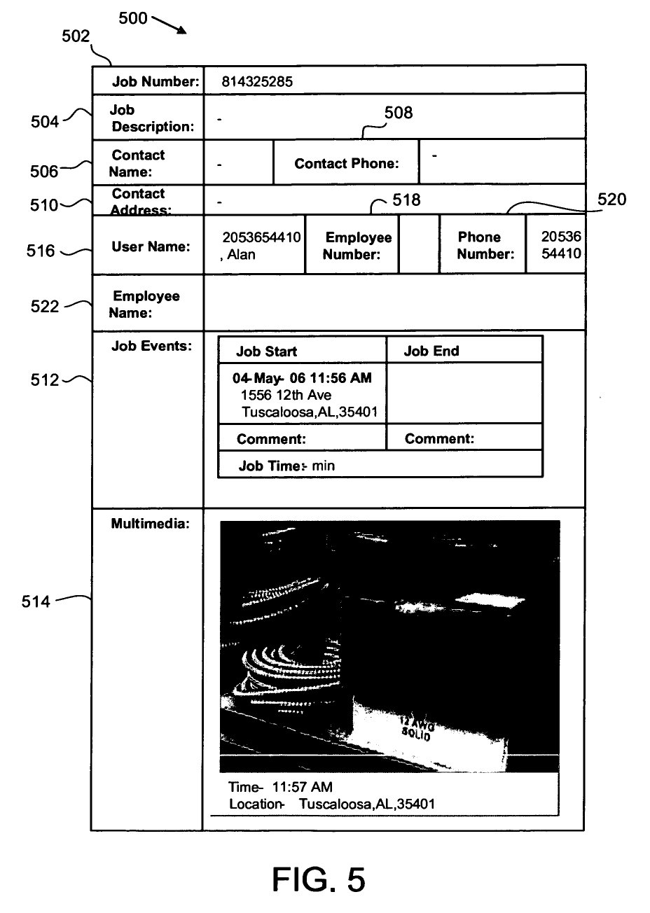

In an embodiment of the invention, employee 104 captures the multimedia content of object 102 after delivering the object 102 to the customer. Further, employee 104 may then store the multimedia content in a job table within the mobile device 106. In an embodiment, the job tables are indexed by job code, or other identifying criteria. Employee 104 may annotate the job table with real-time job-related information (e.g., voice and/or text comments). For example, the employee may want to add a comment regarding delivery of a consignment order. Job table data is stored in the memory of mobile device 106. An exemplary embodiment of a job table is described in detail with reference to FIG. 5 below.

Another example of multimedia content related to job tracking is the ability to describe ones surroundings using either a combination of pictures (using a camera phone), voice notes (by recording into the phone), or both. For example, a building inspector working for the city government may take pictures of building and record commentary, which may decide if a permit is to be issued or not. In another example, a construction supervisor can walk through a newly built home and record notes that may serve as instructions for other workmen to come in and complete unfinished tasks. Live video could also be used in the building inspection example. Another use case for live video is the record the environment where children under foster care live. Government inspectors can provide this information for review by managers in making decisions on whether the children are well cared for in such foster homes.

Those skilled in the art will appreciate that the job tracking system 100 may be used in a myriad of applications and use cases. In general, the job tracking system 100 provides answers to three questions: When did the event happen? The mobile device retrieves accurate time and coupled that with the event. Where did the event happen? The mobile device retrieves its location and couples that to the event. What happened? The mobile device uses a combination of pictures, voice notes, and/or video to describe the environment on or about the event being tracked.

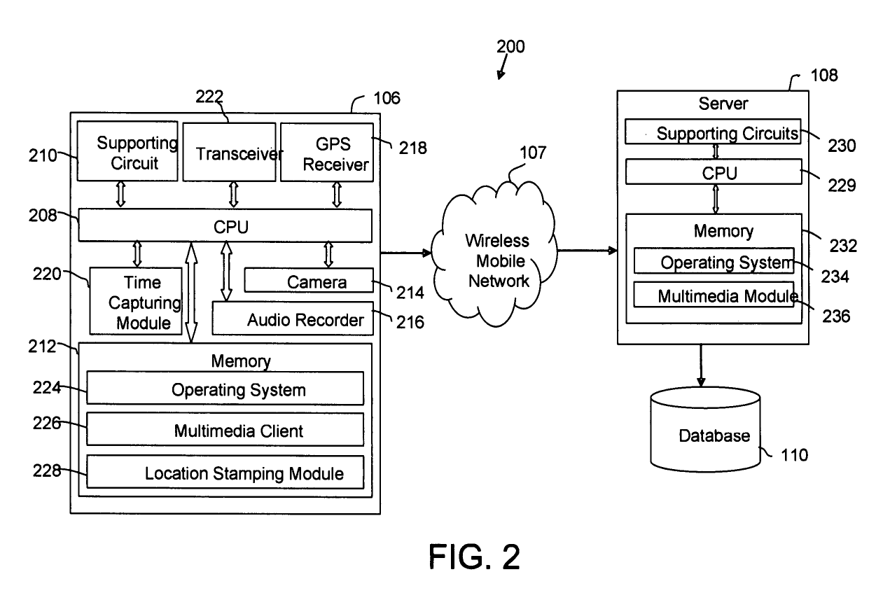

FIG. 2 is a block diagram representation of a job tracking system 200 for tracking the jobs done by the employees at the various job locations, according to an exemplary embodiment of the present invention. Elements of FIG. 2 that are the same or similar to those of FIG. 1 are designed with identical reference numerals. In the present embodiment, the mobile device 106 is a mobile computing device comprising at least one central processing unit (CPU) 208, a transceiver 222, an SPS receiver 218, a time capturing module 220, a camera 214, an audio recorder 216, a memory 212, and supporting circuits 210. CPU 208 comprises at least one microprocessor or microcontroller. Supporting circuits 210 are well-known circuit that supports the operation of CPU 208 and the mobile device 106 including but not limited to, power supplies, cache, input/output circuits, batteries, network cards and the like.

Memory 212 may include but not limited to dynamic or static random access memory, magnetic or optical data storage disks, or magnetic data storage tapes, and the like. Other processing and memory means, including various computer readable media, may be used for storing and executing program instructions. Memory 212 may include an operating system (OS) 224, a multimedia client 226, and a location stamping module 228. OS 222 may comprise various executable application modules. The camera 214 (e.g., a digital camera) and audio recorder 216 may be used alone or in combination to capture multimedia content associated with jobs. The multimedia content for each job may contain, without limitation, an image, a video, an audio or an audio-video file.

The multimedia client 226 manages the multimedia content as captured. In particular, the multimedia client 226 is configured with information related to one or more jobs assigned to the employee. This job-related information may include various pre-defined data items for each job, such as a job identifier, a job description, contact name, contact phone number, contact address, job site address, and the like. The multimedia client 226 generates a job table for each job to be performed. In an embodiment, a job table for a job includes the pre-defined data items for the job. The multimedia client 226 stores the multimedia content captured by the employee for a given job in the job table for the job. The multimedia client 226 also includes time-of-day information and location information in the job table for a job. The multimedia client 226 obtains time-of-day information from the time capturing module 220, and location information from the location stamping module 228. The job table for a job may also include one or more annotations of real-time job-related information, such as text and/or voice comments from the employee about the job, the employee's name, the employee's identification number, and the like.

In an embodiment, a given job includes a sequence of events. For example, for a given job, the employee 104 may have to clock in, get information for performing a job (e.g., driving directions), report start of travel to the job site, report start of the job, capture multimedia content related to the job, report an end of the job, and/or dock out. In an embodiment, the job table records a plurality of events associated with the job in a time-ordered sequence (e.g., each event may receive a time stamp with respect to time-of-day the event was recorded). The location-stamping module 228 uses location information from the SPS receiver 218 to provide location stamps for the events. In an embodiment, each job-related event includes a location stamp based on where the event was performed or recorded. Operation of the SPS receiver 218 is well known in the art. The multimedia client 226 may further perform other functions, including compressing or encrypting the multimedia content.

The multimedia client 226 is configured to transmit the job table data to the server 108 using the transceiver 222. The transceiver 222 is a well known communicating device capable of both transmitting and receiving signals over the wireless mobile network 107 (e.g., a cellular transceiver). Those skilled in the art will appreciate that various transceivers that operate on different frequency bands may be used to implement the transceiver 222, for example CDMA and GSM transceivers. The multimedia client 226 may transmit the job table data to the server 108 in response to a command from the employee, automatically in periodic fashion, automatically in response to a trigger (e.g., after a threshold number of job tables have been generated, at the end of every job, etc.), or automatically in response to a request from the server 108.

The mobile device 106 is preferably coupled with server 108 through the wireless mobile network 107, although any network may be employed, each type with its associated advantages and disadvantages. The server 108 is a computing device comprising at least one central processing unit (CPU) 229, support circuits 230, memory 232, and communication interfaces (not depicted). CPU 229 comprises at least one microprocessor or microcontroller. Support circuits 230 are well-known circuits that support the operation of CPU 229 including but not limited to, power supplies, clocks, cache, input/output circuit, network cards, and the like. Memory 232 may include dynamic or static random access memory, magnetic or optical data storage disks, or magnetic data storage tapes, and the like. Other processing and memory means, including various computer readable media, may be used for storing and executing program instructions. Memory 232 comprises an operating system (OS) 234, and a multimedia module 236. OS 234 may comprise various executable application modules. Multimedia module 236 receives the job table data from the mobile device 106 and stores it to database 110.

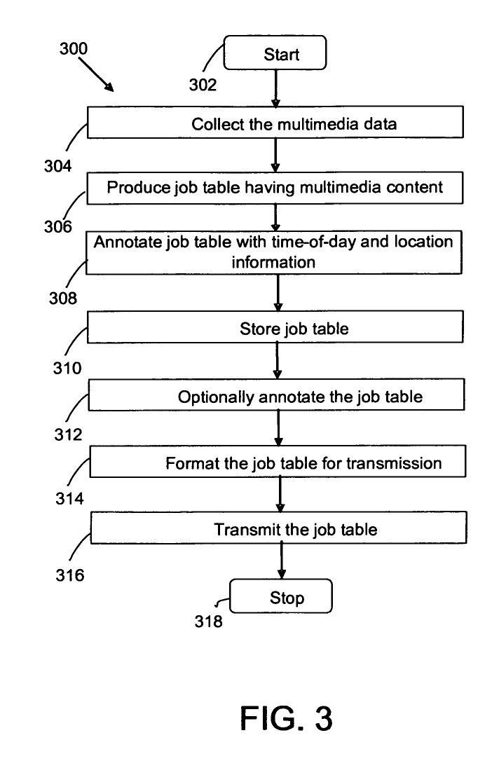

FIG. 3 is a flowchart of a method 300 for tracking performance of a job, according to an exemplary embodiment of the present invention. The method 300 starts at step 302 and proceeds to step 304, wherein an employee collects the multimedia data using a mobile device, such as a cell phone. At step 306, a job table is produced at the mobile device that includes the multimedia content. At step 308, the job table is annotated with time-of-day information and location information. In an embodiment, the job table includes a time-ordered sequence of a plurality of events related to the job. Each of the events may be annotated with a time stamp and/or a location stamp. At step 310, the job table is stored in the memory of the mobile device. The job table may be used as the proof that the job was performed or otherwise completed. At step 312, the employee may optionally annotate the job table with real-time job-related information, as described above. At step 314, the job table may be formatted for transmission. Formatting of the job table may comprise compressing and/or encrypting the job table or a portion of the job table (e.g., the multimedia content). Then, at step 316, the job table is transmitted to a server using a wireless mobile network. The method 300 ends at step 318.

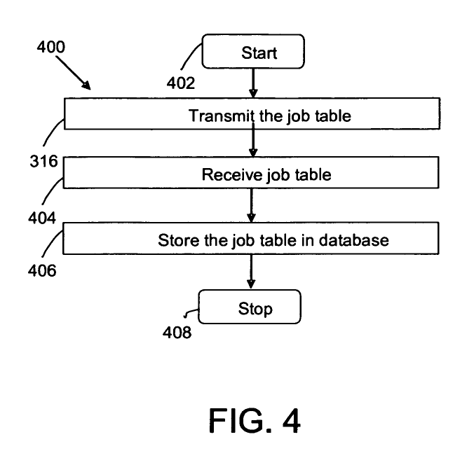

FIG. 4 is a flowchart of a method 400 of uploading a job table to a database, according to an exemplary embodiment of the invention. The method 400 starts at step 402 and proceeds to step 316, wherein the job table is transmitted from a mobile device to a server, preferably using a wireless mobile network. At step 404, the server receives the job table. Next at step 406, the server stores the job table in a database. The method 400 ends at step 408.

FIG. 5 is an exemplary illustration of a job table 500 in accordance with one embodiment of the invention. The job table 500 comprises a plurality of fields. Fields for recording pre-defined job data include a job number field 502, a job description field 504, a contact name field 506, a contact phone field 508, and a contact address field 510. The job table 500 also includes a job events field 512. The job events field 512 includes information related to one or more events related to job performance. In the present example, such events include the start of job and the end of job. Each of the events is annotated with a time stamp (including date) and a location stamp (e.g., an address). In the present example, the job has been started but not yet completed. Each of the events may be further annotated with real-time job related information (e.g., comment field). The job table 500 also includes a multimedia field 514 for recording captured multimedia content. The multimedia content may be time stamped and/or location stamped, as shown. The job table 500 also includes fields for other real-time job-related information, such as user name field 516, an employee number field 518, an employee phone number field 520, and an employee name field 522. Those skilled in the art will appreciate that the job table 500 is merely exemplary and that such job table may be implemented using a myriad of different formats and field.

In the foregoing specification, specific embodiments of the present invention have been described. However, one of ordinary skill in the art will appreciate that various modifications and changes can be made without departing from the spirit and scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. Apparatus for tracking performance of job, comprising:
an interface configured to capture multimedia data related to the job;
a time capturing module for tracking time-of-day;
a location module for determining location;
a multimedia client for producing a job table for the job that includes the multimedia data, time-of-day information from the time capturing module, and location information from the location module; and
a cellular transceiver for transmitting the job table to a server via a wireless mobile network.

2. The apparatus of claim 1, wherein the job table further includes at least one predefined data item.

3. The apparatus of claim 1, wherein the job comprises a plurality of events, and wherein the job table comprises a time-ordered sequence of the plurality of events.

4. The apparatus of claim 3, wherein each of the plurality of events in the time-ordered sequence is associated with a location.

5. The apparatus of claim 1, wherein the job table further includes at least one annotation of real-time job-related information.

6. The apparatus of claim 1, wherein the location module comprises a satellite positioning system (SPS) receiver.

7. The apparatus of claim 1, wherein the interface comprises a camera and an audio recording module, and wherein the multimedia data comprises at least one of an image, a video, audio data, or audio-video data.

8. A method of tracking performance of a job, comprising:
capturing multimedia data related to the job at a mobile device;
producing, at the mobile device, a job table for the job that includes the multimedia data;
annotating the job table with time-of-day information and location information; and
wirelessly transmitting the job table from the mobile device to a server via a wireless mobile network.

9. The method of claim 8, wherein the job table further includes at least one predefined data item.

10. The method of claim 1, wherein the job comprises a plurality of events, and wherein the method further comprises:
recording in the job table a time-ordered sequence of the plurality of events.

11. The method of claim 10, further comprising:
annotating each of the plurality of events in the time-ordered sequence with a location.

12. The method of claim 8, further comprising:
annotating the job table with real-time job-related information.

13. The method of claim 8, wherein the multimedia data comprises at least one of an image, a video, audio data, or audio-video data.

14. A job-tracking system, comprising:
a mobile device configured to capture multimedia data related to a job, produce a job table for the job that includes the multimedia data, time-of-day information, and location information, and wirelessly transmit the job table via a wireless mobile network; and
a server, coupled to the wireless mobile network, the server configured to receive the job table from the mobile device.

15. The system of claim 14, wherein the mobile device comprises:
a time capturing module for tracking time-of-day;
a location module for determining location; and
an interface for capturing the multimedia data.

16. The system of claim 15, wherein the interface includes a camera and an audio recording module, and wherein the multimedia data includes at least one of an image, a video, audio data, or audio-video data.

17. The system of claim 15, wherein the location module comprises a satellite positioning system (SPS) receiver.

18. The system of claim 15, wherein the mobile device comprises a cellular telephone and wherein the wireless mobile network comprises a cellular telephone network.

19. The system of claim 14, wherein the job comprises a plurality of events, and wherein the job table comprises a time-ordered sequence of the plurality of events.

20. The system of claim 19, wherein each of the plurality of events in the time-ordered sequence is associated with a location.
